(19) United States
(12) Patent Application Publication
(10) Pub. No.: US 2022/0365782 A1
(43) Pub. Date: Nov. 17, 2022

(54) INSTRUCTIONS FOR OPERATING ACCELERATOR CIRCUIT

(71) Applicant: Huaxia General Processor Technologies Inc., Beijing (CN)

(72) Inventors: Lei WANG, Beijing (CN); Shaobo SHI, Beijing (CN); Jianjun REN, Beijing (CN)

(73) Assignee: Huaxia General Processor Technologies Inc., Beijing (CN)

(21) Appl. No.: 17/623,324

(22) PCT Filed: Jul. 3, 2019
(86) PCT No.: PCT/CN2019/094511

§ 371 Date: Dec. 28, 2021

(51) Int. Cl. G06F 9/30

(52) U.S. Cl. CPC G06F 9/30036; G06F 9/30098; G06F 9/3001

(57) ABSTRACT

A system includes a memory to store an input data, an accelerator circuit comprising an input command execution circuit, a neuron matrix command execution circuit, and an output command execution circuit, and a processor, communicatively coupled to the memory and the accelerator circuit, to generate a stream of instructions from a source code targeted the accelerator circuit, each one of the stream of instructions comprising at least one of an input command, a neuron matrix command, or an output command, and issue the stream of instructions to the accelerator circuit for execution by the input command execution circuit, the neuron matrix command execution circuit, and the output command execution circuit.

### TECHNICAL FIELD

The present disclosure relates to hardware processor circuits and accelerator circuits, and in particular, to an instruction set architecture of a processor for operating an accelerator circuit.

### BACKGROUND

A processor is a hardware processing device (e.g., a central processing unit (CPU) or a graphic processing unit (GPU)) that implements an instruction set architecture (ISA) containing instructions operating on data elements. A tensor processor (or array processor) may implements an ISA containing instructions operating on tensors of data elements. A tensor is a multi-dimensional data object containing data elements that can be accessed by indices along different dimensions. By operating on tensors containing multiple data elements, tensor processors may achieve significant performance improvements over scalar processors that support only scalar instructions operating on singular data elements.

### BRIEF DESCRIPTION OF THE DRAWINGS

The disclosure will be understood more fully from the detailed description given below and from the accompanying drawings of various embodiments of the disclosure. The drawings, however, should not be taken to limit the disclosure to the specific embodiments, but are for explanation and understanding only.

FIG. 1 illustrates a system including an accelerator circuit according to an implementation of the disclosure.

FIG. 2 illustrates a schematic diagram of an accelerator circuit according to an implementation of the disclosure.

FIG. 3 illustrates a schematic diagram of an engine circuit according to an implementation of the disclosure.

FIG. 4 illustrates a schematic diagram of a local memory reference board according to an implementation of the disclosure.

FIG. 5 illustrates a matrix of computation cells according to an implementation of the disclosure.

FIG. 6 illustrates a schematic diagram of a computation cell according to an implementation of the disclosure.

FIG. 7 is a flow diagram of a method for a processor of a host to use an accelerator circuit to perform a neural network application according to an implementation of the disclosure.

FIG. 8 is a flow diagram of a method for an accelerator circuit to execute a stream of instructions according to an implementation of the disclosure.

### DETAILED DESCRIPTION

Processors, in particular, tensor processors may be employed to perform complex calculations such as, for example, the neural network applications. Neural networks are widely used in artificial intelligence (AI) applications. The neural networks in this disclosure are artificial neural networks which may be implemented on electrical circuits to make decisions based on input data. A neural network may include one or more layers of nodes. The layers can be any of an input layer, hidden layers, or an output layer.

The input layer may include nodes that are exposed to the input data, and the output layer may include nodes that are exposed to the output. The input layer and the output layer are visible layers because they can be observed from outside the neural network. The layers between the input layer and the output layer are referred to as hidden layers. The hidden layers may include nodes implemented in hardware to perform calculations propagated from the input layer to the output layer. The calculations may be carried out using a common set of pre-determined functions such as, for example, filter functions and activation functions. The filter functions may include multiplication operations and summation (also referred to as reduction) operations. The activation function can be any one of an all-pass function, a sigmoid function (sig), or a hyperbolic tangent function (tanh).

In some implementations, the CPU may delegate the GPU to perform the computations relating to the neural network or other computation-intensive tasks. In other implementations, accelerator circuits coupled to the CPU may be implemented to take over the work load of the GPU. An accelerator circuit may include special-purpose hardware circuitry fabricated for accelerating the calculations of the neural network computation. Although the accelerator circuits are currently implemented either in cloud ends or at the device ends may carry out high-performance calculations at relative low costs compared to the GPUs, these implementations of accelerator circuits, compared to the GPUs, are not integrated with the programming interface of the CPU and are thus more difficult to debug by programmers.

To overcome the above-identified issues and other deficiencies of the current implementations of the accelerator circuits, the present disclosure provides technical solutions that include implementations of a hardware accelerator circuit that is programmable by instructions issued by a processor of a host. The processor (CPU, GPU) may be programmed according to an instruction set architecture (ISA) including instructions directed to the accelerator circuit. These instructions, when issued to the accelerator circuit and executed by the accelerator circuit, may use the accelerator circuit to perform certain operations for the host and return results to the host upon successfully finishing the performance.

In one implementation, the instructions directed to the accelerator circuit may be specified within a purely functional framework that allows the direct programming of the accelerator circuits and the convenience for debugging. The purely functional framework treats all computation similar to the evaluation of mathematical functions. By definition, the purely functional framework guarantees that the results of the execution of an instruction within the framework only depends on its arguments regardless of the status of any global or local states. Thus, the results of the executions of instructions within the framework are determined by the input values.

The architectural implementation of the purely functional framework provides certain technical characteristics. All instructions within the framework are memory-to-memory instructions that can be treated as a pure function. A memory-to-memory instruction retrieves data from a first memory, processes the data, and transfers the data to a second memory, where the first memory and the second memory can be identical (or at identical memory location) or different memories. An instruction within the framework can be a single pure function instruction, or a compound pure function constructed from single pure function instructions. Instructions within the framework may be executed in parallel to hide the phases of memory access. The CPU directly controls and monitors the flow of the instruction executions. The framework may provide custom call instructions that allow the accelerator circuits to work cooperatively with other programs executed by the CPU or by other accelerator circuits in another system (e.g., a slave system). The framework may also allow direct acceleration of the instruction without compiler optimization. Further, the framework may allow lazy evaluation (i.e., evaluation of a function when needed) and beta reduction (i.e., calculating the results using an expression input). With the lazy evaluation and beta reduction, the framework can achieve data locality (i.e., the ability to move the computation close to where the data resides on a node rather than moving a large amount of data to the computation location). The framework makes the control flow of the instructions and the behavior of the accelerator circuits observable through programs executed by the CPU with no effects exerted by external states. This ensures that the performance is certain and predictable in a given environment because of the characteristics of the pure function, thus making it easier for programmers to debug their applications.

The framework may provide a multiplication-addition-cumulation (MAC) matrix circuit that includes interconnected (non-separated) computation unit circuits. The CPU may reuse the MAC matrix circuit for convolution, dot product, pooling, and rectified linear units (ReLU) calculations. The framework may allow four dimensional organized local data layout and three dimensional organized MAC matrix to further enhance the capability of the system.

The CPU may execute instructions targeted towards an accelerator circuit. In one implementation, the instruction may be constructed to include four (4) parts: an operation part, a global information part, a local information part, and an internal memory allocation part. The operation part may specify the functionality that the accelerator circuit is to perform. Specifically, the operation part may include a computation field specifying one of a multiplication-addition-cumulation (MAC), a max pooling, or a rectified linear unit (ReLU) calculation.

The global information part may specify parameter values that affect a tensor data as a whole such as, for example the start point, width, height etc. The global information may include four tensors including an input feature map (base, global width, area=global width*global height), a kernel (base, kernel width, kernel height, kernel area=kernel width*kernel height, input kernel size=kernel width*kernel height*global input channels), a partial sum (base, global width (shared with output), global width*global height (shared with output)), and an output feature map (base, global width, global width*global height) as well as a metadata base.

The local information part may specify the dimension values associated with partitions of tensor data such as, for example, the partition width, the partition height, the number of channels associated with the partition etc. Additionally, the local information part may specify the hardware execution preferences to allow the instruction to choose parallel execution on a certain dimension. The local information may include four tensors including a partial sum shared with the output feature map (width before decimation, local width, local width*local height, local output channels), a kernel map (input kernel map size=kernel width*kernel height*local input channels), an input feature map (delta width=input local width−output local width, delta height=input local height−output local height, local input channels), and hardware partitions (partitions of computation units).

The internal memory allocation part may specify the memory banks used for the instruction. The internal memory allocation may include local memory bank identifiers where each identifier is an operand such as, for example, input feature maps, boundary feature maps, kernel maps, partial sum maps, and output feature maps as tensor, vector, or scalar banks. The internal memory allocation information may also include a reuse flag and a no-synchronization flag that are used to combine instructions to form a new complex pure function while saving unnecessary data transfer. The internal memory allocation information may also include a local memory data type to indicate the data type of the operand in the local memory.

The execution of each instruction may include three phases of direct memory access (DMA) input, computation, and DMA output. In the DMA input phase, the accelerator circuit may load the data directly from external memory to local memory associated with the accelerator circuit using a DMA mode. In the computation phase, the accelerator circuit may read the data from the local memory from a source location, perform the calculation, and write the results back to the local memory to a destination location in the local memory. In the DMA output phase, the accelerator circuit may transfer the result data stored in the local memory to the external memory in the DMA mode.

In one implementation, the framework may allow execution of a virtual instruction. A virtual instruction is an instruction that does not have a limit on the size parameters (e.g., width, length, or number of channels). This can be achieved by removing the local information part. The internal memory allocation can be extended to a larger number of memory banks, and each memory bank is to support the holding of the global size of data.

In one implementation, an application may be specified in the form of a source code using a programming language (e.g., C or C++) by a programmer. The application may include operations (e.g., tensor convolution, tensor dot product) relating to neural network calculations. The processor of the host may execute a compiler to convert the source code into machine code based on an implementation of an instruction set architecture (ISA) specified for the processor. In addition to specifying the instructions common for the operation of the processor, the ISA may include specifications for functions directed to the accelerator circuit. These functions may include the input commands for retrieving input data (referred to as the “feature map”) from the memory and/or retrieve the filter data (referred to as the “kernel”) from the memory. These functions may also include neuron matrix commands that specify the calculations performed by the accelerator circuit. These functions may also include output commands for storing the results of the calculations in the memory. The compiler may further combine these commands into a stream of instructions directed to the accelerator circuit. Each instruction may include one or more input commands, one or more neuron matrix commands, and one or more output commands. In one implementation, the input command can be direct-memory access (DMA) input command, and the output command can be DMA output command. The hardware mechanism implemented on the accelerator circuit ensures the correct order of the command execution, thus allowing the execution of commands as a pipeline on the accelerator circuit. The pipeline execution of the commands allows for concurrent executions of commands when there is no conflict for data and resources, thus significantly improving the performance of the accelerator circuit.

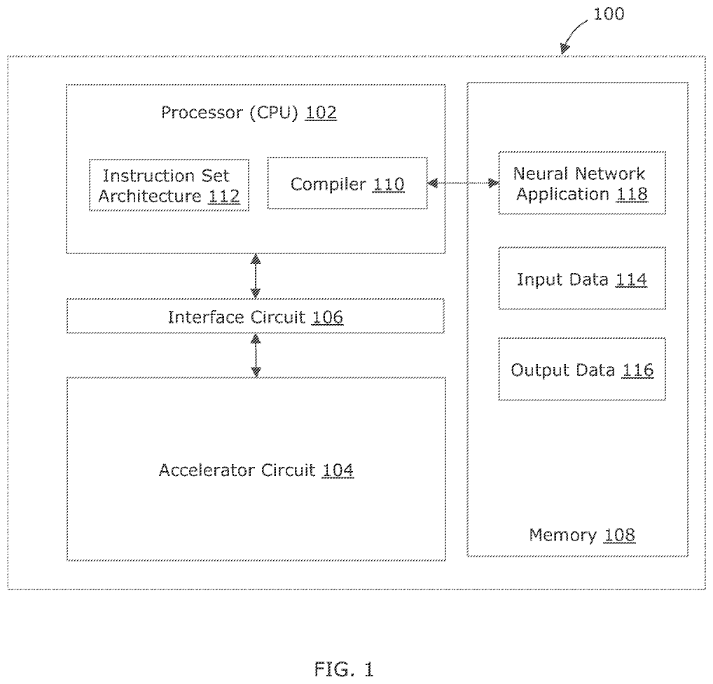

FIG. 1 illustrates a system 100 including an accelerator circuit according to an implementation of the disclosure. System 100 may include a hardware processor (e.g., CPU or GPU) 102, an accelerator circuit 104, and an interface circuit 106 that communicatively connects processor 102 to accelerator circuit 104. Further, system 114 may include a memory 108 that is external to accelerator circuit 104 for storing data.

In one implementation, system 114 can be a computing system or a system-on-a-chip (SoC). Processor 102 can be a hardware processor such as a central processing unit (CPU), a graphic processing unit (GPU), or any suitable types of processing device. Processor 102 may include an instruction execution pipeline (not shown), a register file (not shown), and circuits implementing instructions specified according to an instruction set architecture (ISA) 112.

In one implementation, processor 102 can be a vector/tensor processor that includes a vector/tensor instruction execution pipeline (not shown), a vector/tensor register file (not shown), and circuits implementing vector/tensor instructions specified according to a vector/tensor instruction set architecture (ISA) 112. The vector/tensor instructions may operate on vector/tensor data objects containing a certain number of data elements. For concise description, the disclosure will refer both a scaler and vector/tensor processor as a processor herein. Thus, a processor can be understood as a scaler processor or a vector/tensor processor unless otherwise explicitly specified.

Memory device 108 may include a storage device communicatively coupled to processor 102 and to accelerator circuit 104. In one implementation, memory device 108 may store input data 114 for a neural network application and output data 116 generated by the neural network application. The input data 114 can be a feature map (one or more dimensions) including feature values extracted from application data such as, for example, image data, speech data, Lidar data etc. or a kernel of a filter, and the output data 116 can be decisions made by the neural network, where the decisions may include classification of objects in images into different classes, identification of objects in images, or recognition of phrases in speech. Memory device 108 may also store the source code of a neural network application 118 written in a programming language such as, for example, C or C++. The neural network application 118 may employ certain calculations (e.g., convolution) that require a large amount of computing resources and is more suitable to be carried out on accelerator circuit 104.

System 100 may be installed with a compiler 110 that may convert the source code of neural network application 118 into machine code based on the specification of ISA 112. ISA 112 may include specifications that may convert portions of the source code into machine code that can be executed by accelerator circuit 104. The machine code may include DMA input commands for transferring the input data 114 stored in memory 108 to a local memory of accelerator circuit 104 using direct-memory access, neuron matrix commands that specify the calculations performed by the accelerator circuit 104, and DMA output commands for transferring results from the internal memory of accelerator circuit 104 to memory 108 using direct-memory access. Processor 102 may further execute compiler 110 to combine the DMA input commands, neuron matrix commands, and DMA output commands into a stream of instructions. Each instruction in the stream may include one or more DMA input commands, one or more neuron matrix commands, and one or more DMA output commands. During execution of the neural network application, processor 102 may delegate the execution of the stream of instructions to accelerator circuit 104 by transmitting the stream of instructions to accelerator circuit 104.

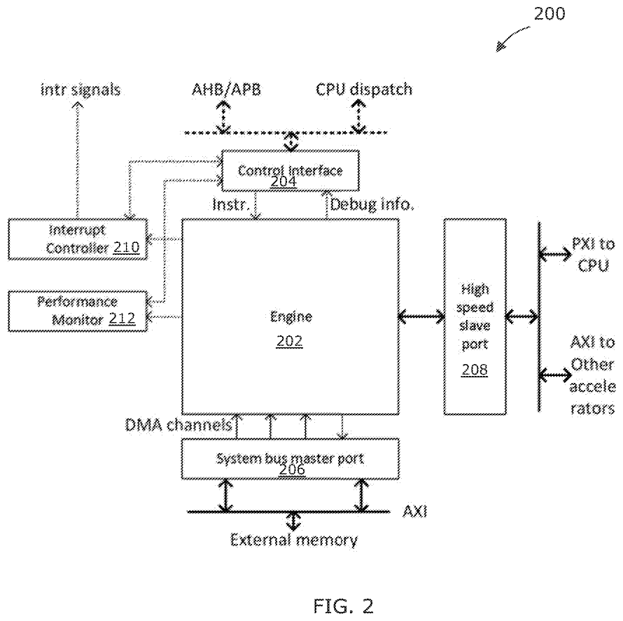

Accelerator circuit 104 may be communicatively coupled to processor 102 and to memory device 108 to perform the computationally-intensive tasks using the special-purpose circuits therein. Accelerator circuit 104 may perform these tasks on behalf of processor 102. For example, processor 102 may be programmed to break down a neural network application into multiple (hundreds or thousands) calculation tasks and delegate the performance of these tasks to accelerator circuit 104. After the completion of these tasks by accelerator circuit 104, processor 102 may receive the calculated results in return. The accelerator circuit 104 can be an application specific integrated circuit (ASIC), a field programmable gate array (FPGA), a digital signal processor (DSP), network processor, or the like. In one implementation, accelerator circuit 104 is implemented within the purely functional platform so that instructions issued by processor 102 to accelerator circuit 104 are executed as pure functions. Thus, the outputs generated by executing the instruction on accelerator circuit 104 depends only on the input values. The purely functional implementation of accelerator circuit 104 allows programmers visibility to the control flow of instruction execution and ability to debug the neuron network applications executed by processor 102. A detailed description of accelerator circuit 104 is provided in the following in conjunction with FIG. 2.

Interface circuit 106 can be a general bus interface implemented to transmit instructions and data from processor 102 to accelerator circuit 104 and/or memory 108. For example, processor 102 may employ interface circuit 106 to issue instructions to accelerator circuit 104, and generate control signals to memory 108 to cause DMA read from memory 108 and DMA write to memory 108.

FIG. 2 illustrates a schematic diagram of an accelerator circuit 200 according to an implementation of the disclosure. As shown in FIG. 2, accelerator circuit 200 may include an engine circuit 202, a control interface 204, a system bus master port 206, an interrupt controller 210, and a performance monitor 212. Accelerator circuit 200 may optionally include a high-speed slave port 208 to connect to another slave system.

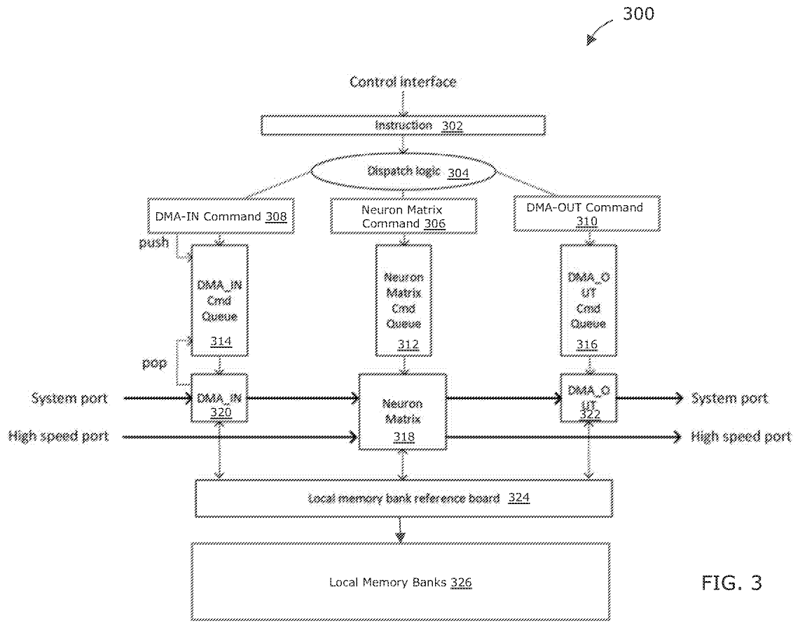

Engine circuit 202 may include instruction parsing and dispatch circuit, asynchronized command queues, a neuron matrix command execution circuit, registers, and local memory banks. At the direction of an instruction issued by a processor (e.g., a CPU, GPU), engine circuit 202 may perform calculations for the processor in a purely functional platform under which the output results generated by the engine circuit 202 depend only on the input values. The calculations performed by engine circuit 202 may include convolution, dot product, ReLU etc. A detailed description of engine circuit 202 is provided in conjunction with FIG. 3.

Control interface 204 may connect engine circuit 202 to a processor (CPU, GPU) of a host so that the processor of the host can issue instructions to engine circuit 202. In one implementation, control interface 204 may be directly connected to the instruction execution pipeline to receive the instructions and configuration data directed to engine circuit 202. In another implementation, control interface 204 is connected to the general bus system of the host to receive the instructions and configuration data directed to engine circuit 202. In both implementations, the instructions and configuration data directed to engine circuit 202 may be identified by an identifier associated with engine circuit 202. Responsive to receiving the instructions from the processor of the host, control interface 204 may pass the instructions received from the processor to engine circuit 202. Responsive to receiving the configuration data, control interface 204 may set the configuration of interrupt controller 210 and performance monitor 212.

System bus master port 206 is an interface for connecting an external memory (external to accelerator circuit 200). The external memory (e.g., memory 108) may store input data that may be transferred to the local memory of engine circuit 202 using the direct-memory access (DMA) input channels, and transfer output results using the DMA output channels from the local memory to the external memory. The DMA input/output may transfer data between the local memory and the main memory independent of the processor of the host, thus reducing the burden of data transfer exerted on the processor of the host. In one implementation, depending on the configuration of the system, system bus master port 206 may be one or two Advanced Extensible Interface (AXI) ports.

High speed slave port 208 is an interface for connecting engine circuit 202 of accelerator circuit 200 to a slave system. The high speed slave port 208 may facilitate the exchange of data between internal memory in engine circuit 202 and an internal memory of the slave system without passing through the main external memory, thus achieving low-latency data transmission between the master system and the slave system.

Performance monitor 212 may include circuit logic to monitor different performance parameters associated with engine circuit 202. Control interface 204 may receive configuration data that may be used to set and unset the performance parameters to be monitored. The performance parameters may include the utilization rate for data transmission and the utilization rate for the neuron matrix command execution circuit within engine circuit 202. The utilization rate for data transmission may measure the amount of data transferred between engine circuit 202 and external memory in view of the channel bandwidth. The utilization rate for the neuron matrix command execution circuit may measure the number of active neuron within the neuron matrix command execution circuit in view of the total number of neurons in the matrix. Performance monitor 212 may feed these performance parameters through control interface back to the processor of the host.

Interrupt controller 210 may generate interrupt signals to the host in response to detecting that a high-priority event associated with engine circuit 202 has occurred. The high-priority events may include a hardware error (or failure) associated with engine circuit 202. Other high-priority events may include command complete, command buffer full or empty events. The interrupt signals may be transmitted to an interrupt handler of the host, where the interrupt handler may further process the interrupt signal on behalf of the processor of the host. For example, the interrupt handler may suspend the current task performed by the processor and direct the processor to handle the interrupt. Alternatively, the interrupt handler may mask the interrupt signal without notifying the processor. In one implementation, control interface 204 may receive configuration data for interrupt controller 210 and set up interrupt controller 210 based on the configuration data. For example, the configuration data may be used to set up flags stored in an interrupt status register. Each flag may correspond to a specific interrupt event. When a flag is set, interrupt controller 210 may forward the interrupt signal corresponding to the interrupt event to the host. When the flag is unset, interrupt controller 210 may ignore the interrupt event and decline to forward the interrupt signal to the host.

As discussed above, engine circuit 202 may receive instructions through control interface 204 from the processor of the host. Some of the instructions may direct engine circuit 202 to perform certain computation tasks (e.g., convolution, dot product, or ReLU). Other instructions may insert check points in the instruction execution streams to provide debug information through control interface 204 back to the processor of the host.

The engine circuit is the part of accelerator circuit that performs data loading, processing, and storing tasks. To this end, engine circuit may be implemented to have two information flows. The first flow (referred to as the “control plane” represented using dashed lines in FIG. 3) may manage the stream of instructions received by control interface. The second flow (referred to as the “data plane” represented by the solid lines in FIG. 3) may manage the data elements of vector/tensor.

FIG. 3 illustrates a schematic diagram of an engine circuit 300 according to an implementation of the disclosure. Referring to FIG. 3, engine circuit 300 may include hardware components of a dispatch logic 304, a neuron matrix command queue 312, a DMA input command queue 314, a DMA output command queue 316, a neuron matrix command execution circuit 318, a DMA input command execution circuit 320, a DMA output instruction execution circuit 322, a local memory bank reference board 324, and local memory banks 326. For the control plane, dispatch logic 304 may receive an instruction 302 from the control interface.

Dispatch logic 304 may parse information associated with the instruction in an instruction stream issued by the processor of the host, and generate commands for the instruction. The commands may include one or more DMA input commands 308, one or more neuron matrix commands 306, and one or more DMA output commands 310. These three types of commands respectively correspond to the DMA input phase, the computation phase, and the DMA output phase of the instruction execution. Dispatcher logic 304 may place DMA input commands 308 in DMA input command queue 314, place neuron matrix commands 306 in neuron matrix command queue 312, and place DMA output commands 310 in DMA output command queue 316. In one implementation, DMA input command queue 314, neuron matrix command queue 312, and DMA output command queue 316 are implemented using stack data structures stored in storage devices (e.g., local registers, local memory). DMA input command queue 314, neuron matrix command queue 312, and DMA output command queue 316 may be implemented as a first-in-first-out (FiFo) queue with a number of entries (e.g., 16 entries in each queue). The FiFo queues ensure that the commands in any one of the three queues are issued sequentially in the order they are placed in the queue. However, there is no requirement for the three commands derived from a same instruction to be executed in sync. Thus, commands in different queues even though they had been derived from a common instruction may be issued out of order. Namely, a command in a queue from a later instruction in the instruction stream may be issued for execution earlier than another command in another queue from an earlier instruction in the instruction stream. The utilization of three queues allows the different commands derived from different instructions to be executed concurrently. This feature enables data preloading (e.g., loading data to the local memory bank prior to the neuron matrix command using the data is issued), thus hiding the memory latency and improving the overall performance of engine circuit 300.

DMA input command execution circuit 320 may receive a DMA input command 308 extracted from DMA input command queue 314 and execute the DMA input command 308; neuron matrix command execution circuit 318 may receive a neuron matrix command 306 extracted from neuron matrix command queue 312 and execute the neuron matrix command 306; DMA output command execution circuit 322 may receive a DMA output command 310 extracted from DMA output command queue 316 and execute the DMA output command 310. Local memory bank reference board 324 may include logic circuit to ensure that although DMA input command 308, neuron matrix command 306, and DMA output command 310 of an instruction are executed in an asynchronized manner, the results of the executions are correct.

In one implementation, local memory bank reference board 324 may include counters implemented in hardware responsible for ensuring commands with interlocking dependencies to be executed in the correct order. Local memory bank reference board 324 may generate signals that control the read and write operations to local memory banks 326. There are two types of dependencies including data dependency and resource dependency. The data dependency may include that the neuron matrix command 306 of an instruction may need the data provided by the DMA input command 308 of the same instruction; the neuron matrix command 306 may need data from the results of a previous neuron matrix command executed by the same neuron matrix command execution circuit; DMA output command 310 of an instruction may need the data from the neuron matrix command 306 of the same instruction. Resource dependency may include that DMA input command 308 cannot write to a local memory bank because the memory bank is being read by neuron matrix command 306 or being output by DMA output command 310 to the external memory; neuron matrix command cannot write to a local memory bank because the memory bank is being output by DMA output command 310 to the external memory.

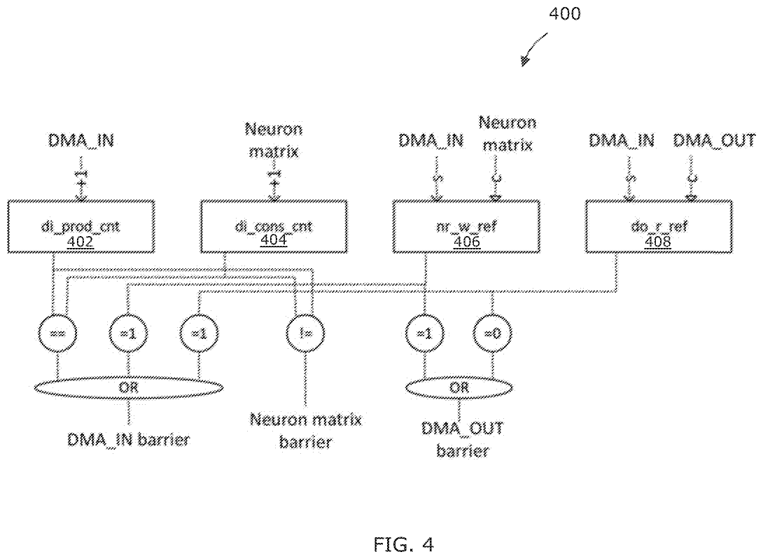

FIG. 4 illustrates a schematic diagram of a local memory reference board 400 according to an implementation of the disclosure. Local memory reference board 400 may include hardware counters to ensure the correct order of command execution based on the data dependencies and resource dependencies. Referring to FIG. 4, local memory reference board 400 may include counters 402, 404, and reference registers 406, 408 that may be used to generate signals to control the read and write operations to the local memory bank 326.

In one implementation, each memory bank in local memory banks 326 may be provided with a DMA input barrier signal, a neuron matrix barrier signal and a DMA output barrier signal. These barrier signals may determine whether the memory bank can be read or write. DMA input command execution circuit 320 may cause an increment of counter 402 (di_prod_cnt) by one in response to determining that DMA input command execution circuit 320 finishes the data transmission to a memory bank, indicating that there is a new read reference (or an address pointer) to the memory bank. Neuron matrix command execution circuit 318 may cause an increment of counter 404 (di_cons_cnt) in response to determining that neuron matrix command execution circuit 318 is done reading the memory bank. When the value (di_prod_cnt) stored in counter 402 equals the value (di_cons_cnt) stored in counter 404, the references produced by DMA input command execution circuit 320 are all consumed by neuron matrix command execution circuit 318. In this situation, neuron matrix command execution circuit 318 needs to wait for more new references. When the value (di_prod_cnt) stored in counter 402 does not match the value (di_cons_cnt) stored in counter 404, the references produced by DMA input command execution circuit 320 before have not consumed by neuron matrix command execution circuit 318 and DMA input command execution circuit 318 needs to wait. A special situation is when a reuse flag associated with the memory bank is set, DMA input command execution circuit 320 may cause an increment of counter 402 without waiting for all previous references being consumed. This allows the execution of more DMA input commands in advance.

DMA input command execution circuit 320 may set reference register 406 (nr_w_ref) when the DMA input command execution circuit 320 starts to reserve the access right to the memory bank for saving the calculation results. This marks the start point of the execution of the instruction. The reference register 406 may be cleared by neuron matrix command execution circuit 318 when the calculation results are saved to the memory bank. DMA input command execution circuit 320 or neuron matrix command execution circuit 318 may set reference register 408 (do_r_ref), indicating that the data stored in the memory bank is being transferred to the external memory. DMA output command execution circuit 322 may clear reference register 408, indicating that the data had been transferred out to the external memory and the memory bank is released.

Counters 402, 404, and reference registers 406, 408 are provided for each local memory bank Thus, all commands must check all barrier signals prior to execution. As shown in FIG. 4, DMA input barrier signal is set by any one of the conditions: (1) di_prod_cnt==di_cons_cnt; or rn_w_ref is set to 1; or do_r_ref is set to 1. Neuron matrix barrier signal is set if di_prod_cnt!=di_cons_cnt. DMA output barrier signal is set by any one of the conditions: (1) nr_w_ref=1; or (2) do_r_ref=0. The barrier signal may prevent the execution of a corresponding command. For example, when DMA input barrier signal is set, DMA command execution circuit 320 may halt access to the memory bank; when neuron matrix barrier signal is set, neuron matrix command execution circuit 318 may suspend access to the memory bank; when DMA output barrier signal is set, DMA output command execution circuit 322 may suspend access to the memory bank.

The example implementation shown in FIG. 4 includes only one neuron matrix command execution circuit and one DMA output command execution circuit. Therefore, reference registers 406, 408 include only one bit flag that can be set to one or unset to zero. Other implementations may include more than one neuron matrix command execution circuits or more than one DMA output command execution circuits, counters (like those 402, 404) can be used in place of the bit flags.

Referring to FIG. 3, there are two data flows for the data plane associated with the engine circuit. An active data flow may include the retrieving data from external memory to local memory banks 326 by executing DMA input command 308, processing the data by neuron matrix command execution circuit and storing the data back to the local memory banks 326, and writing data out to external memory by executing DMA output command 322. The active data flow is controlled by the engine circuit 300 with all requests being issued by the engine circuit 300. A passive data flow includes data flowing from external memory directly neuron matrix command execution circuit 318 and from neuron matrix command execution circuit 318 to the external memory. A passive data flow includes data flowing for neuron matrix command execution circuit 318 to retrieve data from the internal memory and to store results in the internal memory.

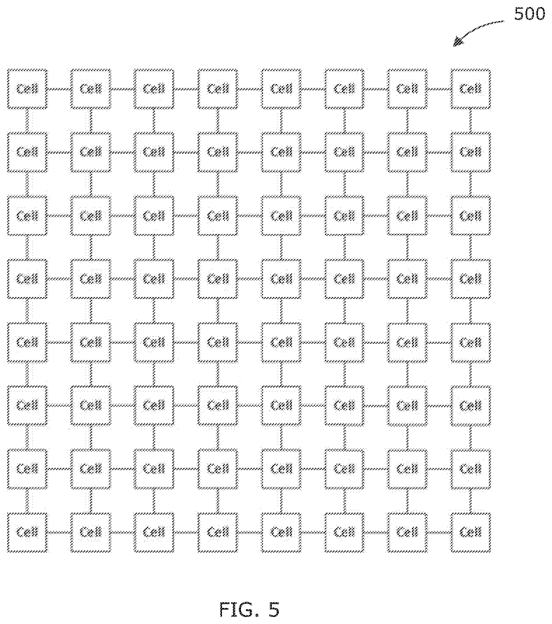

Neuron matrix command execution circuit may perform the operations specified by the operation code (opcode) in the operation part of the instruction. Neuron matrix command execution circuit may include a matrix of computation cells and a barrier signal control logic. FIG. 5 illustrates a matrix of computation cells 500 according to an implementation of the disclosure. The matrix can be a square matrix with equal numbers of cells along the x and y dimensions or a rectangular matrix with unequal numbers of cells along the x and y dimensions. As shown in FIG. 5, cells within the two-dimensional array are connected in the horizontal (x) and vertical (y) dimensions. Each cell may include a set of dimension counters, feeder circuits, a writer circuit, an array of computation units, and a set of local memory banks. Thus, the matrix of cells where each cell includes an array of computation units are particularly suitable for performing tensor computation. A tensor data object is a data cube that is indexed along three or more dimensions while an array object is a data array that is indexed along two dimensions.

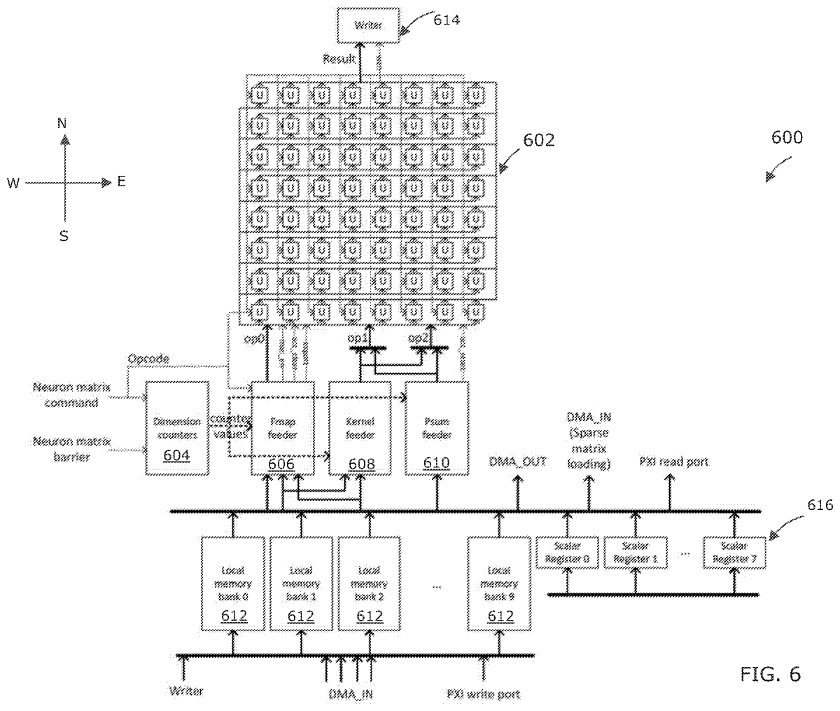

Each computation cell may be configured to perform a vector operation using the array of computation units therein. FIG. 6 illustrates a schematic diagram of a computation cell 600 according to an implementation of the disclosure. Referring to FIG. 6, computation cell 600 may include an array of computation units (each unit represented by a U) 602 and control logic circuits. The control logic circuits may include dimension counters 604, three feeder circuits 606, 608, 610, local memory banks 612, a writer circuit 614, and scaler registers 616. Computation cell 600 may operate on data stored in the local memory based the neuron matrix command and neuron matrix barrier signal directed to the cell. Each computation unit is a single circuit block that may perform a type of calculation under the control of one or more control signals. The control signals can be grouped into two groups. The first group of control signals are generated by decoding the neuron matrix command and are independent from the internal elements of the cell in the sense that the first group of control signals are set once the neuron matrix command is issued to the neuron matrix command execution circuit. The first group of control signals are applied to all computation units. The second group of control signals are dynamically generated internally based on the values stored in dimension counters 604 by the first feeder circuit 606 (Fmap feeder). The second group of control signals may vary as applied to different computation units within the array. The second group of control signals may include, as discussed later, mac_en, acc_clear_en, export, acc_reset_en etc. These control signals are enabled when dimension counters cross the boundaries of a data structure (e.g., an array) to perform higher dimension operations such as, for example, 3D tensor, depth-wise, point-wise, element-wise etc. The second group of control signals may help ensure each computation unit has correct input/output values and correct calculation result with the two-dimensional array structure.

Dimension counters 604 may be used to count down different dimension values associated with the calculation. In one implementation, neuron matrix barrier signal may be provided to dimension counters 604 for enabling or disabling the computation cell. If the neuron matrix barrier signal is set (e.g., to 1), dimension counters may be disabled and prevented from access by the neuron matrix command. If neuron matrix barrier signal is not set (e.g., at 0), dimension counters may be initialized by the neuron matrix command. The neuron matrix command may provide dimension counters with initial values representing the heights and widths of the input data (referred to as the feature map) and the filter data (referred to as the kernel). The computation is to apply the filter (e.g., a high/low pass filter) onto the input data (e.g., a 2D image) using convolution.

Dimension counters 604 may include a kernel width counter, a kernel height counter, an input channel counter, an input area counter (height and/or width of the input), and an output channel counter. The kernel width counter and kernel height counter may store the width and height of the kernel. The input channel counter may specify the number of times to retrieve data from memory bank. For certain calculations, there may be a need to retrieve the input data multiple times because the size limitation of the computation unit. A large feature map may be partitioned into smaller portions that are processed separately. In such situation, the channel counter may store the number of portions associated with a feature map. The output channel counter may specify the memory bank to receive the output results. For example, the output channel counter may store the number of times to perform the convolution calculation on these portions of the feature map. The total amount of computation may be proportional to kernel width*kernel height*partition counter*input channel counter*output channel counter.

The values stored in dimension counters may be fed to feeder circuits 606, 608, 610. Feeder circuit 606 (Fmap feeder) may control the transfer of input data (feature map, or partial feature map) from local memory banks 612. Feeder circuit 608 (kernel feeder) may control the transfer of the kernel from the local memory banks 612. Feeder circuit 610 (psum feeder) may control the transfer of the partial sum values in the local memory banks 612. Feeder circuit 606 may, based on values stored in dimension counters 604 and an opcode received from the neuron matrix command, supply operand values (op0s) to the computation units and control signals mac_en, acc_clear, and export. Feeder circuits 608, 610 may be combined to supply other two operands (op1s, op2s) to the computation units. Feeder circuit 610 may generate control signal acc_reset. The operand values op0s can be the reference to a local memory bank from which the feature map can be retrieved; the operand values op1s may be the reference to local memory banks that provide the kernel; the operand values op2s may be the reference to the local memory banks for storing the partial sums.

Control signals may be enabled and disabled based on values stored in dimension counters. When the kernel width counter or the kernel height counter stores a non-zero value, feeder circuit 606 may set mac_en signal, triggering a multiplication-addition-cumulation (MAC) operation. When the value in the kernel width counter is decreased, feeder circuit 606 may enable a shift-to-west signal, causing the values in the array of computation units 602 to shift to the west direction (N, S, E, W as shown in FIG. 6 respectively represent north, south, east, west direction). When the value in the kernel height counter is decreased, feeder circuit 606 may enable a shift-to-north signal, causing the values in the array of computation units 602 to shift to the north direction. When the value in the input channel counter is decreased, feeder circuit 606 may enable a feature-map-ready signal, indicating that the feature map is ready to be read by the array of computation units for calculation. When the value in the input area counter is decreased, feeder circuit 606 may enable acc_clear and export signals, causing the export of the results from computation units to the local memory banks and the clearing of the accumulators in the computation units.

Feeder circuit (Fmap feeder) controls the transfer of operands of feature map data and boundary feature map data from local memory banks into four types of buffers. The four types of buffers may include an operand buffer for supplying op0s to computation units, an east boundary buffer for supplying the eastern neighbor data value to the area holding the operand buffer, a south boundary buffer for supplying the southern neighbor data value to the area holding the operand buffer, and a corner (or southeast) boundary buffer for supplying the eastern neighbor data value to the area holding south boundary buffer.

Operand buffer and east boundary buffer may be implemented in three (3) levels. Level-0 buffer is used for the Fmap feeder to retrieve data (from local memory bank) to the level-0 buffer; level-1 buffer is used to hold the data for the north direction shifting; level-2 buffer is used to hold the data for east direction shifting. When the feature-map-ready signal is enabled for the first time, the Fmap feeder reads the data into level-0 buffer, and after the computation units finish processing the data in level-0 buffer, the Fmap feeder may push the data values in the level-0 buffer to the level-1 buffer and release the level-0 buffer for loading next block of data when the feature-map-ready signal is enabled again. Data values stored in the level-2 buffer are shifted to the west in response to enabling the shift-to-west signal. Fmap feeder may reload the data from the level-1 buffer and shift the data values in the level-1 buffer to the north by one row in response to enabling the shift-to-north signal. Although the multi-level buffer scheme may require more buffers, the multi-level buffer scheme may significantly reduce the amount of connection wires when there are thousands of computation units. Each buffer may be associated with bit flags that each identifies whether a row or a column is the last valid row or column. The rows or columns identified by the big flags as the last row or column may be automatically padded with zeros at the end when the data is shifted either to the north for a column or to the east for a row.

The address to access the local memory banks 612 may be calculated based on the input area (stride: 1), the input channel (stride: feature map height rounding to multiples of the cell height, where rounding ensures that data at the same position from different input channels are fed into the same unit), the feature map height counter, and the output channel.

Kernel feeder 608 may control the transfer of the data in the local memory bank for kernel maps operand. The kernel feeder may include two levels of buffers, with the level-0 buffer holding a row of kernel elements from the memory bank and the level-1 buffer holding the duplicated element which is broadcasted to all units in the cell.

Psum feeder 610 may control the transfer of the data in the local memory bank for partial sum maps operand. Psum feeder may include only one level of buffer.

Writer circuit 614 may control data output from computation units into the local memory banks. A computation unit may issue a write-enable (wen) signal to enable an activation unit in the writer and then write the output of the activation unit into local memory. The activation unit supports linear, ReLU, sigmoid and tanh functions.

Scalar registers 616 may be addressed and referenced in manner similar to local memory banks. The scalar registers 616 may store scalar values that may be applied to elements in a feature map. For example, a scalar register 616 may store a multiplier value that may be applied to each element in a feature map.

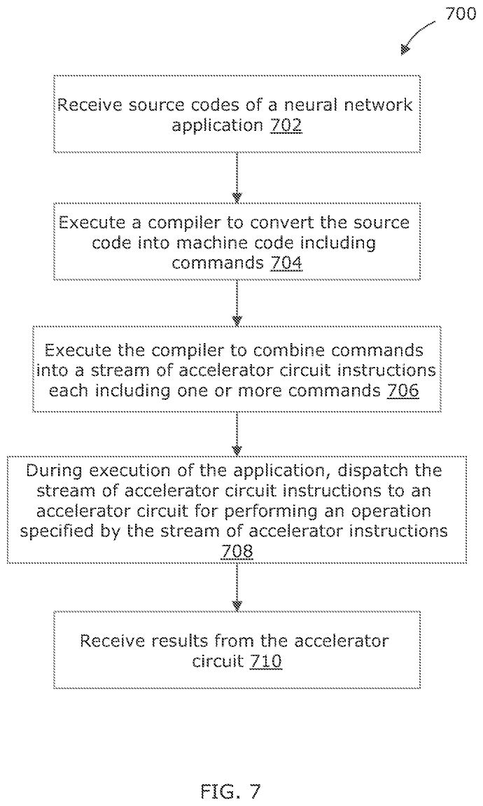

The processor of a host may employ the accelerator circuit to perform computation tasks. FIG. 7 is a flow diagram of a method 700 for a processor of a host to use an accelerator circuit to perform a neural network application according to an implementation of the disclosure.

As shown in FIG. 7, at 702, the processor may receive the source code of a neural network application to compile the application into machine code that can be executed by the processor or the accelerator circuit.

At 704, the processor may execute the compiler to convert the source code into machine code. The machine code may include commands that can be executed by the accelerator circuit.

At 706, the processor may further execute the compiler to combine the some commands directed to the accelerator circuit into a stream of accelerator circuit instructions each including one or more commands. In one implementation as discussed above, each accelerator circuit instruction may include one or more DMA input command, one or more neuron matrix command, and one or more DMA output command. The stream of accelerator circuit instructions may constitute part of the executable code of the neural network application.

At 708, during the execution of the neural network application, the processor may dispatch the stream of accelerator circuit instructions to the accelerator circuit for performing an operation specified by the stream of accelerator circuit instructions. For example, the stream of accelerator circuit instruction may specify the filtering of a tensor feature map that may need computation support from the accelerator circuit.

At 710, the processor receives results from the accelerator circuit after it has successfully completed the operation specified by the stream of accelerator circuit instructions.

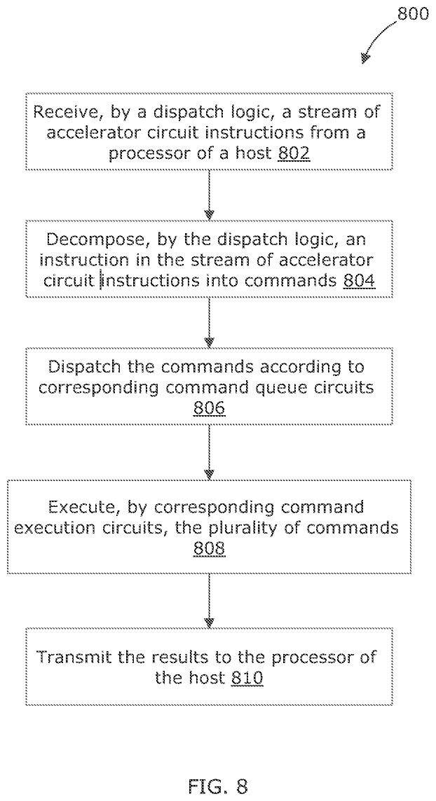

The accelerator circuit may perform the operation specified by the stream. FIG. 8 is a flow diagram of a method 800 for an accelerator circuit to execute a stream of accelerator circuit instructions according to an implementation of the disclosure.

As shown in FIG. 8, at 802, the accelerator circuit may include a dispatch logic that may receive the stream of accelerator circuit instructions from a processor of a host. The stream of accelerator circuit instructions may specify an operation to be performed by the accelerator circuit.

At 804, the dispatch logic may decompose an accelerator circuit instruction in the stream of accelerator circuit instructions into commands including one or more DMA input commands, one or more neuron matrix commands, and one or more DMA output commands.

At 806, the dispatch logic may store the commands into command queues according to their type. For example the one or more DMA input commands may be stored in the DMA command queue; the one or more neuron matrix commands may be stored in the neuron matrix command queue; one or more the DMA output commands may be stored in the DMA command queue.

At 808, the command execution circuits may execute the commands stored in the corresponding queues. For example, the DMA input command execution circuit may execute the DMA input commands according to the order in the DMA input command queue; the neuron matrix command execution circuit may execute the neuron matrix commands according to the order in the neuron matrix command queue; the DMA output command execution circuit may execute the DMA output commands according to the order in the DMA output command queue.

At 810, the accelerator circuit may transmit the results generated by the neuron matrix command execution circuit back to the processor. This may be achieved by the execution of the DMA output commands.

Implementations of the disclosure may provide a library of functions directed to the accelerator circuit. These functions, when called by the neural network application, may deploy the accelerator circuit to perform certain computationally-intensive tasks on behalf of the processor of the host. The library of functions that may be called from a C programming language source code is provided in the following.

The functions defined in the library may use a tensor data object. A partition intrinsic call may return a set of partitioned dimensions that may facilitate the optimum use of the accelerator circuit. The returned value associated with a tensor is defined as:

```
typedef struct {
  unsigned short id; // tensor identifier
  unsigned short oh; //tensor height
  unsigned short ow; //tensor width
  unsigned short od; //tensor depth
}_{——}partition_t
```

The compiler may be provided with certain intrinsic functions (referred to as intrinsics or builtin functions). The intrinsics are available for use in a given programming language (e.g., C) handled specifically by the compiler. Tensor intrinsic functions as provided in the following support constant reduction when all or some of the arguments are constant values. The compiler may statically optimize the tensor dimension associated with the constant value.

The partition intrinsic functions may include the following function calls.

4D convolution partition
_{——}partition_t_{——}builtin_gptx_tensor_part(uint32_t h, uint32_t w, uint32_t in_ch, uint32_t
out_ch, uint32_t kh, uint32_t kw);

The 4D convolution partition function can be used for 4 dimensional tensor convolution which is not depthwised (3D) or not a dot product (2D), wherein h and w may respectively represent the feature map height and width, in_ch and out_ch may respectively represent the input channel and output channel, and kh and kw may respectively represent the kernel height and kernel width.

Depthwise partition
_{——}partition_t_{——}builtin_gptx_tensor_part_dw(uint32_t h, uint32_t w, uint32_t in_ch, uint32_t
kh, uint32_t kw);

The od value in return partition values is undefined because it is the same as id value.

Dot product partition
_{——}partition_t_{——}builtin_gptx_tensor_part_dp(uint32_t out_ch)

In the Dot production partition function, out_ch for dot product is the length of the output vector. The id in return partition values is undefined because it is always 1 for dot product.

Pooling partition
_{——}partition_t_{——}builtin_gptx_tensor_part_dw(uint32_t h, uint32_t w, uint32_t in_ch, uint32_t
kh, uint32_t kw, uint32_t stride_h, uint32_t stride_w);

Pooling partition function is similar to the depthwise partition except for the feature map along the height direction is subsampled with a stride_h and along the width direction is subsampled with a stride_w.

The load functions may load tensor data to the accelerator circuit. Tensor register type is used to define the tensor register variables to be passed among tensor intrinsic functions. The tensor variables can be allocated by the compiler at the runtime when the compiler and the architecture support the tensor registers. Alternatively, tensor variables can be allocated as a memory when tensor register is not available. In one implementation, the type size is fixed similar to packed SIMD types (e.g., _t16×128×8×8_fp16_t). In another implementation, the type size will support variable size for all of its dimensions.

### Load Intrinsic Functions

The load intrinsic functions include the following functions:

Basic load intrinsic functions:
void _{——}builtin_gptx_tensor_Id_u_b(_{——}t16x128x8x8_fp16_t dest, void *src, uint16_t global_w,
uint32_t global_a, uint16_t local_d, uint16_t local_h, uint16_t local_w); //load instruction to
load unsigned byte data (8 bits)
void _{——}builtin_gptx_tensor_Id_s_b(_{——}t16x128x8x8_fp16_t dest, void *src, uint16_t global_w,
uint32_t global_a, uint16_t local_d, uint16_t local_h, uint16_t local_w); //load instruction to
load signed byte data (8 bits)
void _{——}builtin_gptx_tensor_Id_hf(_{——}t16x128x8x8_fp16_t dest, void *src, uint16_t global_w,
uint32_t global_a, uint16_t local_d, uint16_t local_h, uint16_t local_w); //load instruction to
load half-precision floating point format (half) data (16 bits)
Table lookup load intrinsic functions:
void _{——}builtin_gptx_tensor_Id_tab_b(_{——}t16x128x8x8_fp16_t dest, void *src, uint16_t global_w,
uint32_t global_a, uint16_t local_d, uint16_t local_h, uint16_t local_w, void *tab); //load
instruction to load look-up table data, byte data (8 bits)
void _{——}builtin_gptx_tensor_Id_tab_n(_{——}t16x128x8x8_fp16_t dest, void *src, uint16_t global_w,
uint32_t global_a, uint16_t local_d, uint16_t local_h, uint16_t local_w, void *tab); //load
instruction to load look-up data, nibble data (4 bits)
Sparse load intrinsic functions:
void _{——}builtin_gptx_tensor_Id_tab_n(_{——}t16x128x8x8_fp16_t dest, void *src, uint16_t global_w,
uint32_t global_a, uint16_t local_d, uint16_t local_h, uint16_t local_w, void *tab); //load
instruction to load look-up table for decompress, nibble data (4 bits)

### Load Extension Intrinsic Functions

Load extension intrinsic functions are functions that can be applied on the destination of load and computation and on the source of the store intrinsics. In compilation, the compiler may be required to combine the load extension intrinsic functions into its extending intrinsics based on the extension. The intermediate result is eliminated.

Duplications
void _{——}builtin_gptx_tensor_dup_fmap(_{——}t16x128x8x8_fp16_t dest, _{——}t16x128x8x8_fp16_t
src); //duplicate instruction to duplicate feature map data, usually with a load instruction
void _{——}builtin_gptx_tensor_dup_kmap(_{——}t16x128x8x8_fp16_t dest, _{——}t16x128x8x8_fp16_t
src); //duplicate instruction to duplicate a kernel map data, usually with a load instruction
Transpose
void _{——}builtin_gptx_tensor_trp(_{——}t16x128x8x8_fp16_t dest, _{——}t16x128x8x8_fp16_t src);
//transpose instruction to transpose the tensor data, usually with a load instructions or a store
instruction
Padding
void _{——}builtin_gptx_tensor_pad(_{——}t16x128x8x8_fp16_t dest, _{——}t16x128x8x8_fp16_t src,
uint8_t n, uint8_t w); // padding instruction to pad the input feature map data to the west and
north (with data the same to the east and south correspondingly)

### Computation Intrinsic Functions

Addition
void _{——}builtin_gptx_tensor_add_tt(_{——}t16x128x8x8_fp16_t dest, _{——}t16x128x8x8_fp16_t src0,
_{——}t16x128x8x8_fp16_t src1, uint16_t d, uint16_t h, uint16_t w); //dest tensor = src0 tensor +
src1 tensor
void _{——}builtin_gptx_tensor_add_tv(_{——}t16x128x8x8_fp16_t dest, _{——}t16x128x8x8_fp16_t src0,
_{——}vfp16x2048_t src1, uint16_t d, uint16_t h, uint16_t w); //dest tensor = src0 tensor + src1
vector
void _{——}builtin_gptx_tensor_add_ts(_{——}t16x128x8x8_fp16_t dest, _{——}t16x128x8x8_fp16_t src0,
_{——}fp16_t src1, uint16_t d, uint16_t h, uint16_t w); //dest tensor = src0 tensor + src1 scalar
Multiplication
void _{——}builtin_gptx_tensor_mul_tt(_{——}t16x128x8x8_fp16_t dest, _{——}t16x128x8x8_fp16_t src0,
_{——}t16x128x8x8_fp16_t src1, uint16_t od, uint16_t oh, uint16_t ow, uint8_t h2, uint8_t w2); //
tensor dest = src0 tensor * src1 tensor
void _{——}builtin_gptx_tensor_mul_tv(_{——}t16x128x8x8_fp16_t dest, _{——}t16x128x8x8_fp16_t src0,
_{——}vfp16x2048_t src1, uint16_t od, uint16_t oh, uint16_t ow, uint8_t h2, uint8_t w2); //dest
tensor = src0 tensor * src1 vector
void _{——}builtin_gptx_tensor_mul_ts(_{——}t16x128x8x8_fp16_t dest, _{——}t16x128x8x8_fp16_t src0,
_{——}fp16_t src1, uint16_t od, uint16_t oh, uint16_t ow, uint8_t h2, uint8_t w2); //dest tensor =
src0 tensor * src1 scalar
Multiplication and Addition
void _{——}builtin_gptx_tensor_mac_ttt(_{——}t16x128x8x8_fp16_t dest, _{——}t16x128x8x8_fp16_t src0,
_{——}t16x128x8x8_fp16_t src1, _{——}t16x128x8x8_fp16_t src2, uint16_t od, uint16_t oh, uint16_t
ow, uint8_t h2, uint8_t w2); //dest tensor = src0 tensor * src1 tensor + src2 tensor
void _{——}builtin_gptx_tensor_mac_tvt(_{——}t16x128x8x8_fp16_t dest, _{——}t16x128x8x8_fp16_t src0,
_{——}vfp16x2048_t src1, _{——}t16x128x8x8_fp16_t src2, uint16_t od, uint16_t oh, uint16_t ow,
uint8_t h2, uint8_t w2); //dest tensor = src0 tensor * src1 vector + src2 tensor
void _{——}builtin_gptx_tensor_mac_ttv(_{——}t16x128x8x8_fp16_t dest, _{——}t16x128x8x8_fp16_t src0,
_{——}t16x128x8x8_fp16_t src1, _{——}vfp16x2048_t src2, uint16_t od, uint16_t oh, uint16_t ow,
uint8_t h2, uint8_t w2); //dest tensor = src0 tensor * src1 tensor + src2 vector
void _{——}builtin_gptx_tensor_mac_tvv(_{——}t16x128x8x8_fp16_t dest, _{——}t16x128x8x8_fp16_t src0,
_{——}vfp16x2048_t src1, _{——}vfp16x2048_t src2, uint16_t od, uint16_t oh, uint16_t ow, uint8_t h2,
uint8_t w2); //dest tensor = src0 tensor * src1 vector + src2 vector
void _{——}builtin_gptx_tensor_mac_tst(_{——}t16x128x8x8_fp16_t dest, _{——}t16x128x8x8_fp16_t src0,
_{——}fp16_t src1, _{——}t16x128x8x8_fp16_t src2, uint16_t od, uint16_t oh, uint16_t ow, uint8_t h2,
uint8_t w2); //dest tensor = src0 tensor *src1 scalar + src2 tensor
void _{——}builtin_gptx_tensor_mac_tts(_{——}t16x128x8x8_fp16_t dest, _{——}t16x128x8x8_fp16_t src0,
_{——}t16x128x8x8_fp16_t src1, _{——}fp16_t src2, uint16_t od, uint16_t oh, uint16_t ow, uint8_t h2,
uint8_t w2); //dest tensor = src0 tensor * src1 tensor + src2 scalar
void _{——}builtin_gptx_tensor_mac_tsv(_{——}t16x128x8x8_fp16_t dest, _{——}t16x128x8x8_fp16_t src0,
_{——}fp16_t src1, _{——}vfp16x2048_t src2, uint16_t od, uint16_t oh, uint16_t ow, uint8_t h2, uint8_t
w2); // dest tensor = src0 tensor * src1 scalar + src2 vector
void _{——}builtin_gptx_tensor_mac_tvs(_{——}t16x128x8x8_fp16_t dest, _{——}t16x128x8x8_fp16_t src0,
_{——}vfp16x2048_t src1, _{——}fp16_t src2, uint16_t od, uint16_t oh, uint16_t ow, uint8_t h2, uint8_t
w2); //dest tensor = src0 tensor * src1 vector + src2 scalar
void _{——}builtin_gptx_tensor_mac_tvs(_{——}t16x128x8x8_fp16_t dest, _{——}t16x128x8x8_fp16_t src0,
_{——}fp16_t src1, _{——}fp16_t src2, uint16_t od, uint16_t oh, uint16_t ow, uint8_t h2, uint8_t w2); //
dest tensor = src0 tensor * src1 scalar + src2 scalar

Compared to the following 4D Multiplication instructions, the above Multiplication and Addition instructions are directed to 3D operations that have no reduce/accumulate operations among multiple channel calculations.

4D Multiplication
void _{——}builtin_gptx_tensor_mul4_tt(_{——}t16x128x8x8_fp16_t dest, _{——}t16x128x8x8_fp16_t src0,
_{——}t16x128x8x8_fp16_t src1, uint16_t od, uint16_t d2, uint16_t oh, uint16_t ow, uint8_t h2,
uint8_t w2); //tensor dest[i] = reduce (tensor src0 * tensor src1 [i]); compose tensor dest[0] −
[i] into the final tensor dest; slice number of tensor dest is od (the slice of tensor src0 multiplies
the slice of tensor srce1[i] and accumulates into one slice, the number of tensor srce1 is od, and
slice number of resulting tensor from this function is also od)
void _{——}builtin_gptx_tensor_mul4_tv(_{——}t16x128x8x8_fp16_t dest, _{——}t16x128x8x8_fp16_t src0,
_{——}vfp16x2048_t src1, uint16_t od, uint16_t d2, uint16_t oh, uint16_t ow, uint8_t h2, uint8_t
w2); //similar to above except for the src1 is a vector
void _{——}builtin_gptx_tensor_mul4_ts(_{——}t16x128x8x8_fp16_t dest, _{——}t16x128x8x8_fp16_t src0,
_{——}fp16_t src1, uint16_t od, uint16_t d2, uint16_t oh, uint16_t ow, uint8_t h2, uint8_t w2);
//similar to above except for the src1 is a scalar
void _{——}builtin_gptx_tensor_mac4_ttt(_{——}t16x128x8x8_fp16_t dest, _{——}t16x128x8x8_fp16_t src0,
_{——}t16x128x8x8_fp16_t src1, _{——}t16x128x8x8_fp16_t src2, uint16_t od, uint16_t d2, uint16_t oh,
uint16_t ow, uint8_t h2, uint8_t w2); //similar to above but having an initial accumulate tensor
dest[i] = reduce(tensor src0 * tensor src1[i] + tensor src2[i])
void _{——}builtin_gptx_tensor_mac4_tvt(_{——}t16x128x8x8_fp16_t dest, _{——}t16x128x8x8_fp16_t src0,
_{——}vfp16x2048_t src1, _{——}t16x128x8x8_fp16_t src2, uint16_t od, uint16_t d2, uint16_t oh,
uint16_t ow, uint8_t h2, uint8_t w2); //similar to above but having an initial accumulate tensor
dest[i] = reduce(tensor src0 * vector src1[i] + tensor src2[i])
void _{——}builtin_gptx_tensor_mac4_ttv(_{——}t16x128x8x8_fp16_t dest, _{——}t16x128x8x8_fp16_t src0,
_{——}t16x128x8x8_fp16_t src1, _{——}vfp16x2048_t src2, uint16_t od, uint16_t d2, uint16_t oh,
uint16_t ow, uint8_t h2, uint8_t w2); //similar to above but having an initial accumulate tensor
dest[i] = reduce(tensor src0 * tensor src1[i] + vector src2[i])
void _{——}builtin_gptx_tensor_mac4_tvv(_{——}t16x128x8x8_fp16_t dest, _{——}t16x128x8x8_fp16_t
src0, _{——}vfp16x2048_t src1, _{——}vfp16x2048_t src2, uint16_t od, uint16_t d2, uint16_t oh,
uint16_t ow, uint8_t h2, uint8_t w2); //similar to above but having an initial accumulate tensor
dest[i] = reduce(tensor src0 * vector src1[i] + vector src2[i])
void _{——}builtin_gptx_tensor_mac4_tst(_{——}t16x128x8x8_fp16_t dest, _{——}t16x128x8x8_fp16_t src0,
_{——}fp16_t src1, _{——}t16x128x8x8_fp16_t src2, uint16_t od, uint16_t d2, uint16_t oh, uint16_t ow,
uint8_t h2, uint8_t w2); //similar to above but having an initial accumulate tensor dest[i] =
reduce(tensor src0 * scalar src1 + tensor src2[i])
void _{——}builtin_gptx_tensor_mac4_tts(_{——}t16x128x8x8_fp16_t dest, _{——}t16x128x8x8_fp16_t src0,
_{——}t16x128x8x8_fp16_t src1, _{——}fp16_t src2, uint16_t od, uint16_t d2, uint16_t oh, uint16_t ow,
uint8_t h2, uint8_t w2); //similar to above but having an initial accumulate tensor dest[i] =
reduce(tensor src0 * tensor src1[i] + scalar src2)
void _{——}builtin_gptx_tensor_mac4_tsv(_{——}t16x128x8x8_fp16_t dest, _{——}t16x128x8x8_fp16_t src0,
_{——}fp16_t src1, _{——}vfp16x2048_t src2, uint16_t od, uint16_t d2, uint16_t oh, uint16_t ow,
uint8_t h2, uint8_t w2); // similar to above but having an initial accumulate tensor dest[i] =
reduce(tensor src0 * scalar src1 + vector src2[i])
void _{——}builtin_gptx_tensor_mac4_tvs(_{——}t16x128x8x8_fp16_t dest, _{——}t16x128x8x8_fp16_t src0,
_{——}vfp16x2048_t src1, _{——}fp16_t src2, uint16_t od, uint16_t d2, uint16_t oh, uint16_t ow,
uint8_t h2, uint8_t w2); // similar to above but having an initial accumulate tensor dest[i] =
reduce(tensor src0 * vector src1[i] + scalar src2)
void _{——}builtin_gptx_tensor_mac4_tvs(_{——}t16x128x8x8_fp16_t dest, _{——}t16x128x8x8_fp16_t src0,
_{——}fp16_t src1, _{——}fp16_t src2, uint16_t od, uint16_t d2, uint16_t oh, uint16_t ow, uint8_t h2,
uint8_t w2); // similar to above but having an initial accumulate tensor dest[i] = reduce(tensor
src0 * scalar src1 + scalar src2[i])
Activation functions
ReLU
void _{——}builtin_gptx_tensor_relu(_{——}t16x128x8x8_fp16_t dest, _{——}t16x128x8x8_fp16_t src0,
uint16_t d, uint16_t h, uint16_t w); //tensor dest = ReLU (tensor src0)
Leaky ReLU
void _{——}builtin_gptx_tensor_leaky_relu(_{——}t16x128x8x8_fp16_t dest, _{——}t16x128x8x8_fp16_t
src0, _{——}fp16_t src1, uint16_t d, uint16_t h, uint16_t w); //tensor dest = leaky ReLU(tensor src0)
PReLU
void _{——}builtin_gptx_tensor_leaky_relu(_{——}t16x128x8x8_fp16_t dest, _{——}t16x128x8x8_fp16_t
src0, _{——} t16x128x8x8_fp16_t src1, uint16_t d, uint16_t h, uint16_t w); //tensor dest =
PReLU(tensor src0)
Logistic
void _{——}builtin_gptx_tensor_sigmoid(_{——}t16x128x8x8_fp16_t dest, _{——}t16x128x8x8_fp16_t src0,
uint16_t d, uint16_t h, uint16_t w); //tensor dest = Sigmoid(tensor src0)
Tanh
void _{——}builtin_gptx_tensor_tanh(_{——}t16x128x8x8_fp16_t dest, _{——}t16x128x8x8_fp16_t src0,
uint16_t d, uint16_t h, uint16_t w); //tensor dest = Tanh(tensor src0)
Reduce Max
void _{——}builtin_gptx_tensor_rmax(_{——}t16x128x8x8_fp16_t dest, _{——}t16x128x8x8_fp16_t src0,
uint16_t d, uint16_t h, uint16_t w, uint8_t h2, uint8_t w2); //dest tensor = Reduce Max(src0
tensor) with the kernel of height of h and width of w

### Store Functions

void _{——}builtin_gptx_tensor_st_u_b(_{——}t16x128x8x8_fp16_t src, void *dest, uint16_t global_w,
uint32_t global_a, uint16_t local_d, uint16_t local_h, uint16_t local_w, uint8_t stride_h,
uint8_t stride_w); //store tensor src in dest //store instruction to store unsigned byte data (8
bits)
void _{——}builtin_gptx_tensor_st_s_b(_{——}t16x128x8x8_fp16_t src, void *dest, uint16_t global_w,
uint32_t global_a, uint16_t local_d, uint16_t local_h, uint16_t local_w, uint8_t stride_h,
uint8_t stride_w); //store instruction to store signed byte data (8 bits)
void _{——}builtin_gptx_tensor_st_hf(_{——}t16x128x8x8_fp16_t src, void *dest, uint16_t global_w,
uint32_t global_a, uint16_t local_d, uint16_t local_h, uint16_t local_w, uint8_t stride_h,
uint8_t stride_w); //store instruction to store hafl data (16 bits)

The compiler may convert the compiler-specific intrinsic functions into machine code including machine instructions that can be executed by the accelerator circuit. The machine instructions can be 32, 64, or 96 bit long. The instruction may be encoded with 32 bits per line with a first bit reserved for a bit flag that, when set (e.g., to 1), indicates the 32 bit line is not the end of the instruction and when unset (e.g., to 0), indicates the 32 bit line is the end of the instruction.

Each machine instruction may include a first portion (e.g., 12 bits) to encode the operation code and a second portion (e.g., 36 bits) to encode operands that the operation is applied to. The machine instructions include the following instructions:

The compiler may further combine the machine instructions to form the accelerator circuit instruction. Table 1 is an example code for convolution between a feature map and a kernel.

void conv_hf(fp16* src, fp16*kernel, fp16*dest)
{
_{——}gptx_glob0_t glob_fmap;
_{——}gptx_loc0_t loc;
_{——}gptx_loc_pad_t pad;
_{——}gptx_dual_tensor_t fb = _{——}builtin_gptx_ldtddup0_conv_hf(src, glob_fmap, loc, pad);//FN1
_{——}gptx_glob1_t glob_kern;
_{——}gptx_loc1_t loc;
_{——}gptx_tensor_t kb = _{——}builtin_gptx_ldtdup1f_conv_hf(kernel, glob_kern, loc);//FN2
_{——}gptx_loc3_t loc;
_{——}gptx_cal_dim_t comp;
_{——}gptx_tensor_t ob = _{——}builtin_gptx_mad_conv_dual(fb, kb, NULL_BANK, loc, comp,
FN_NOOP);//FN3
_{——}gptx_glob2_t glob;
_{——}gptx_loc2_t loc;
_{——}builtin_gptx_sttsf_hf(dest, ob, glob, loc);//FN4
}

The code as shown in Table 1 may be compiled by a compiler to generate the machine code. The processor may execute the machine code and delegate the computational-intensive convolution task to an accelerator circuit. The convolution function conv_hf includes three parameters including the feature map address *src, kernel map address, *kernel, and the destination address *dest. The convolution function contains four sub-functions including FN1 for loading the feature map, FN2 for loading the kernel map, FN3 for neuron matrix computation, and FN4 for storing the results. Each of the sub-functions may be preceded by preparation of parameters. The outputs of FN1-FN3 are the local bank identifiers, where fb or kb is the local bank identifier for storing the feature map or kernel map retrieved from the external memory, and ob is the identifier for the local bank storing the results from neuron matrix calculation. Each call to the convolution function conv_hf may achieve the convolution of a slice of data in the tensor. A loop may be used to achieve the convolution on the full tensor.

During compilation, the source code of conv_hf may be converted into machine code. The machine code may be combined into a single accelerator instruction wherein the machine code of FN1 and FN2 may constitute the DMA input command, FN2 may constitute the neuron matrix command, and FN4 may constitute the DMA output command. The accelerator instruction may be issued to the accelerator circuit for execution as described in conjunction with FIGS. 2-6.

Example 1 is a system including a memory to store an input data, an accelerator circuit comprising an input command execution circuit, a neuron matrix command execution circuit, and an output command execution circuit, and a processor, communicatively coupled to the memory and the accelerator circuit, to generate a stream of instructions from a source code targeted the accelerator circuit, each one of the stream of instructions comprising at least one of an input command, a neuron matrix command, or an output command, and issue the stream of instructions to the accelerator circuit for execution by the input command execution circuit, the neuron matrix command execution circuit, and the output command execution circuit.

While the disclosure has been described with respect to a limited number of embodiments, those skilled in the art will appreciate numerous modifications and variations there from. It is intended that the appended claims cover all such modifications and variations as fall within the true spirit and scope of this disclosure.

A design may go through various stages, from creation to simulation to fabrication. Data representing a design may represent the design in a number of manners. First, as is useful in simulations, the hardware may be represented using a hardware description language or another functional description language. Additionally, a circuit level model with logic and/or transistor gates may be produced at some stages of the design process. Furthermore, most designs, at some stage, reach a level of data representing the physical placement of various devices in the hardware model. In the case where conventional semiconductor fabrication techniques are used, the data representing the hardware model may be the data specifying the presence or absence of various features on different mask layers for masks used to produce the integrated circuit. In any representation of the design, the data may be stored in any form of a machine readable medium. A memory or a magnetic or optical storage such as a disc may be the machine readable medium to store information transmitted via optical or electrical wave modulated or otherwise generated to transmit such information. When an electrical carrier wave indicating or carrying the code or design is transmitted, to the extent that copying, buffering, or re-transmission of the electrical signal is performed, a new copy is made. Thus, a communication provider or a network provider may store on a tangible, machine-readable medium, at least temporarily, an article, such as information encoded into a carrier wave, embodying techniques of embodiments of the present disclosure.

A module as used herein refers to any combination of hardware, software, and/or firmware. As an example, a module includes hardware, such as a micro-controller, associated with a non-transitory medium to store code adapted to be executed by the micro-controller. Therefore, reference to a module, in one embodiment, refers to the hardware, which is specifically configured to recognize and/or execute the code to be held on a non-transitory medium. Furthermore, in another embodiment, use of a module refers to the non-transitory medium including the code, which is specifically adapted to be executed by the microcontroller to perform predetermined operations. And as can be inferred, in yet another embodiment, the term module (in this example) may refer to the combination of the microcontroller and the non-transitory medium. Often module boundaries that are illustrated as separate commonly vary and potentially overlap. For example, a first and a second module may share hardware, software, firmware, or a combination thereof, while potentially retaining some independent hardware, software, or firmware. In one embodiment, use of the term logic includes hardware, such as transistors, registers, or other hardware, such as programmable logic devices.

Use of the phrase ‘configured to,’ in one embodiment, refers to arranging, putting together, manufacturing, offering to sell, importing and/or designing an apparatus, hardware, logic, or element to perform a designated or determined task. In this example, an apparatus or element thereof that is not operating is still ‘configured to’ perform a designated task if it is designed, coupled, and/or interconnected to perform said designated task. As a purely illustrative example, a logic gate may provide a 0 or a 1 during operation. But a logic gate ‘configured to’ provide an enable signal to a clock does not include every potential logic gate that may provide a 1 or 0. Instead, the logic gate is one coupled in some manner that during operation the 1 or 0 output is to enable the clock. Note once again that use of the term ‘configured to’ does not require operation, but instead focus on the latent state of an apparatus, hardware, and/or element, where in the latent state the apparatus, hardware, and/or element is designed to perform a particular task when the apparatus, hardware, and/or element is operating.

Furthermore, use of the phrases ‘to,’ ‘capable of/to,’ and or ‘operable to,’ in one embodiment, refers to some apparatus, logic, hardware, and/or element designed in such a way to enable use of the apparatus, logic, hardware, and/or element in a specified manner. Note as above that use of to, capable to, or operable to, in one embodiment, refers to the latent state of an apparatus, logic, hardware, and/or element, where the apparatus, logic, hardware, and/or element is not operating but is designed in such a manner to enable use of an apparatus in a specified manner.

A value, as used herein, includes any known representation of a number, a state, a logical state, or a binary logical state. Often, the use of logic levels, logic values, or logical values is also referred to as 1's and 0's, which simply represents binary logic states. For example, a 1 refers to a high logic level and 0 refers to a low logic level. In one embodiment, a storage cell, such as a transistor or flash cell, may be capable of holding a single logical value or multiple logical values. However, other representations of values in computer systems have been used. For example, the decimal number ten may also be represented as a binary value of 910 and a hexadecimal letter A. Therefore, a value includes any representation of information capable of being held in a computer system.

Moreover, states may be represented by values or portions of values. As an example, a first value, such as a logical one, may represent a default or initial state, while a second value, such as a logical zero, may represent a non-default state. In addition, the terms reset and set, in one embodiment, refer to a default and an updated value or state, respectively. For example, a default value potentially includes a high logical value, i.e. reset, while an updated value potentially includes a low logical value, i.e. set. Note that any combination of values may be utilized to represent any number of states.

The embodiments of methods, hardware, software, firmware or code set forth above may be implemented via instructions or code stored on a machine-accessible, machine readable, computer accessible, or computer readable medium which are executable by a processing element. A non-transitory machine-accessible/readable medium includes any mechanism that provides (i.e., stores and/or transmits) information in a form readable by a machine, such as a computer or electronic system. For example, a non-transitory machine-accessible medium includes random-access memory (RAM), such as static RAM (SRAM) or dynamic RAM (DRAM); ROM; magnetic or optical storage medium; flash memory devices; electrical storage devices; optical storage devices; acoustical storage devices; other form of storage devices for holding information received from transitory (propagated) signals (e.g., carrier waves, infrared signals, digital signals); etc., which are to be distinguished from the non-transitory mediums that may receive information there from.

Instructions used to program logic to perform embodiments of the disclosure may be stored within a memory in the system, such as DRAM, cache, flash memory, or other storage. Furthermore, the instructions can be distributed via a network or by way of other computer readable media. Thus a machine-readable medium may include any mechanism for storing or transmitting information in a form readable by a machine (e.g., a computer), but is not limited to, floppy diskettes, optical disks, Compact Disc, Read-Only Memory (CD-ROMs), and magneto-optical disks, Read-Only Memory (ROMs), Random Access Memory (RAM), Erasable Programmable Read-Only Memory (EPROM), Electrically Erasable Programmable Read-Only Memory (EEPROM), magnetic or optical cards, flash memory, or a tangible, machine-readable storage used in the transmission of information over the Internet via electrical, optical, acoustical or other forms of propagated signals (e.g., carrier waves, infrared signals, digital signals, etc.). Accordingly, the computer-readable medium includes any type of tangible machine-readable medium suitable for storing or transmitting electronic instructions or information in a form readable by a machine (e.g., a computer).

Reference throughout this specification to “one embodiment” or “an embodiment” means that a particular feature, structure, or characteristic described in connection with the embodiment is included in at least one embodiment of the present disclosure. Thus, the appearances of the phrases “in one embodiment” or “in an embodiment” in various places throughout this specification are not necessarily all referring to the same embodiment. Furthermore, the particular features, structures, or characteristics may be combined in any suitable manner in one or more embodiments.

In the foregoing specification, a detailed description has been given with reference to specific exemplary embodiments. It will, however, be evident that various modifications and changes may be made thereto without departing from the broader spirit and scope of the disclosure as set forth in the appended claims. The specification and drawings are, accordingly, to be regarded in an illustrative sense rather than a restrictive sense. Furthermore, the foregoing use of embodiment and other exemplarily language does not necessarily refer to the same embodiment or the same example, but may refer to different and distinct embodiments, as well as potentially the same embodiment.

What is claimed is:

1. A system, comprising:
a memory to store an input data;
an accelerator circuit comprising an input command execution circuit, a neuron matrix command execution circuit, and an output command execution circuit; and
a processor, communicatively coupled to the memory and the accelerator circuit, to:
generate a stream of instructions from a source code targeted the accelerator circuit, each one of the stream of instructions comprising at least one of an input command, a neuron matrix command, or an output command; and
issue the stream of instructions to the accelerator circuit for execution by the input command execution circuit, the neuron matrix command execution circuit, and the output command execution circuit.

2. The system of claim 1, wherein the input command is a load instruction comprising:
an operation code indicating at least one of a type of data duplication on hardware partitions, a target operation, or a data type;
a first operand representing a base address corresponding to a start point of the input data stored in the memory;
a second operand representing a reference to a first register storing a global dimension information;
a third operand representing a reference to a second register storing a local dimension information; and
a fourth operand representing an address indicating a destination of the input data in a local memory of the accelerator circuit.

3. The system of claim 2, wherein the type of data duplication on hardware partitions comprises duplicating a first data value in all cells in a hardware partition of the accelerator circuit, duplicating a second data value in a cell in a first hardware partition to a corresponding cell in a second hardware partition of the accelerator circuit, or no duplication,
wherein the target operation is one of a convolution or a dot product, and
wherein the data type is one of unsigned byte, signed byte, a half precision floating point, a floating point, or an integer.

4. The system of claim 2, wherein the global dimension information comprises a width and an area of the input data, and wherein the local dimension information comprises a width, a height, and a depth of a portion of the input data.

5. The system of claim 2, wherein the local memory comprises a plurality of local memory banks, and wherein the destination comprises an identifier of one of the plurality of local memory banks.

6. The system of claim 1, wherein the output command comprising:
an operation code indicating a data store operation;
a first operand representing an address indicating a source of the output data in a local memory of the accelerator circuit;
a second operand representing a reference to a first register storing a global dimension information;
a third operand representing a reference to a second register storing a local dimension information; and
a fourth operand representing a base address corresponding to a start point of the output data stored in the memory.

7. The system of claim 6, wherein the global dimension information comprises a width and an area of the input data, wherein the local dimension information comprises a width, a height, and a depth of a portion of the input data.

8. The system of claim 6, wherein the local memory comprises a plurality of local memory banks, and wherein the source comprises an identifier of one of the plurality of local memory banks.

9. The system of claim 1, wherein the neuron matrix command comprising:
an operation code indicating at least one of a calculation, one or more dimensions of operands, an activation function, or a target operation;
at least one of a first operand representing a first source of data to the calculation, a second operand representing a second source of data to the calculation, or a third operand representing a third source of data to the calculation;
a fourth operand representing a destination of a result of the calculation; and
a fifth operand representing a reference to a first register storing a local dimension information.

10. The system of claim 9, wherein the calculation of the neuron matrix command comprises one of a multiplication and addition (MADD), a rectified linear unit (ReLU), or a reduce maximum tensor, wherein the one or more dimensions of operands of the neuron matrix command comprise a tensor and a vector, wherein the activation function of the neuron matrix command comprises one of no activation, a ReLU function, a tanh function, or a Sigmoid function, and wherein the target operation of the neuron matrix command is one of a convolution or a dot product.

11. The system of claim 10, wherein the MADD operation is to multiply a data element from the first source of data with a data element from the second source of data to generate an intermediate result, and add the intermediate result with a data element from the third source of data to generate the results.

12. The system of claim 10, wherein the reduce maximum tensor operation is to determine a maximum value in the first source of data.

13. The system of claim 1, wherein the processor is to:
identify a plurality of intrinsic functions associated with the accelerator circuit in the source code;
execute a compiler to convert the plurality of intrinsic functions into a plurality of machine instructions; and
generate each of the stream of instructions by combining one or more of the plurality of machine instructions.

14. The system of claim 1, wherein the accelerator circuit comprises:
a control interface to receive the stream of instructions;
the local memory; and
an engine circuit, communicatively coupled to the control interface and the local memory, the engine circuit comprising:
a dispatch circuit to decode an instruction of the stream of instructions into the input command, the neuron matrix command, and the output command;
an input command queue circuit to store the input command in an input command queue, a neuron matrix command execution circuit to store the neuron matrix command in a neuron matrix command queue, and an output command queue circuit to store the output command in an output command queue; and
the input command execution circuit to execute the input command, the neuron matrix execution circuit to execute the neuron matrix command, and the output command execution circuit to execute the output command.

15. The system of claim 14, wherein the input command execution circuits, the neuron matrix command execution circuit, and the output command execution circuit are to respectively execute the input command, the neuron matrix command, and the output command decoded from the instruction without synchronization.

16. The system of claim 15, wherein the input command is a direct-memory access (DMA) input command, and the output command is a DMA output command.

17. The system of claim 14, wherein the neuron matrix command execution circuit comprises:
a matrix of computation cells that each is connected to at least another computation cell of the matrix, wherein each computation cell in the matrix of computation cells comprises:
an array of computation units;
a plurality of dimension counters;
a plurality of feeder circuits communicatively coupled to the array of computation units; and
a plurality of local memory banks associated with the plurality of feeder circuits.

18. A method comprising:
identifying, by a processor, a source code comprising a plurality of intrinsic functions directed to an accelerator circuit;
converting, by the processor, the source code into a machine code comprising a plurality of machine instructions corresponding to the plurality of intrinsic functions;
combining, by the processor, one or more of the plurality of machine instructions into an accelerator circuit instruction; and
issuing, by the processor, the accelerator circuit instruction to the accelerator circuit for execution.

19. The method of claim 18, further comprising:
generating a stream of accelerator circuit instructions; and
issuing the stream of accelerator circuit instructions to the accelerator circuit.

20. The method of claim 18, wherein the accelerator circuit instruction comprises at least one of an input command, a neuron matrix command, or an output command.

21. The method of claim 20, wherein the accelerator circuit comprises an input command execution circuit to execute the input command, a neuron matrix command execution circuit to execute the neuron matrix command, and an output command execution circuit to execute the output command.
